(19) United States
(12) Patent Application Publication
(10) Pub. No.: US 2002/0026476 A1
(43) Pub. Date: Feb. 28, 2002

(54) Informing system and method

(76) Inventors: Takao Miyazaki, Asaka-shi (JP); Tomoyoshi Nishimura, Asaka-shi (JP)

Correspondence Address: BIRCH STEWART KOLASCH & BIRCH, PO BOX 747, FALLS CHURCH, VA, 22040-0747, US

(21) Appl. No.: 09/941,563

(22) Filed: Aug. 30, 2001

(30) Foreign Application Priority Data
Aug. 31, 2000 (JP) 2000-263309

(51) Int. Cl. G06F 15/16

(52) U.S. Cl. 709/203

(57) ABSTRACT

An informing system for informing a user through a local area network comprises a properties file producing device that produces a properties file and an informing device that informs the user according to the properties file. The properties file shows the following; whether or not an informing job has priority over other informing jobs, whether the informing job will be performed automatically or manually, a range of the informing job, and which communication apparatus will perform the informing job. Therefore, the informing job can be appropriately performed according to the priority and so on.

### BACKGROUND OF THE INVENTION

1. Field of the Invention

The present invention relates generally to an informing system and an informing method, and more particularly to an informing system and an informing method in which an informing device informs a user through a local area network.

2. Description of the Related Art

Japanese Patent Application Laid-open No. 10-187387 discloses a print system that analyzes print requests and determines an order of priority of print jobs to print efficiently. However, the print jobs are performed in an order set in a printer no matter what the order of priority is.

Japanese Patent Application Laid-open No. 5-282584 discloses a remote building security system that can quickly deal with multiple abnormalities even when they occur at one time. However, the security system counts the number of the abnormalities, and prints abnormality data only when the number of the abnormalities is a predetermined number or larger.

### SUMMARY OF THE INVENTION

In view of the foregoing, it is an object of the present invention to provide an informing system and an informing method in which an informing job can be performed according to priority and so on of the informing job.

To achieve the above-mentioned object, the present invention is directed to an informing system for informing a user through a local area network, the informing system comprising: a properties file producing device that produces a properties file showing at least one of the following; whether or not an informing job has priority over other informing jobs, whether the informing job will be performed automatically or manually, a range of the informing job, and which communication apparatus will perform the informing job; and an informing device that informs the user according to the properties file produced by the properties file producing device.

According to the present invention, the informing system for informing the user through the local area network comprises the properties file producing device that produces the properties file showing at least one of the following; whether or not the informing job has the priority over the other informing jobs, whether the informing job will be performed automatically or manually, the range of the informing job, and which communication apparatus will perform the informing job; and the informing device that informs the user according to the properties file produced by the properties file producing device. Therefore, the informing job can be appropriately performed according to the priority and so on of the informing job.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a diagram showing a structure of a home network;

FIG. 2 is a block diagram of a refrigerator if it serves as a server;

FIG. 3 is a block diagram of a telephone if it serves as a server;

FIG. 4 is a diagram showing contents of a properties file;

FIG. 5 is a diagram showing a selection screen displayed on a display of a terminal;

FIG. 6 is a diagram showing a bell properties screen displayed on the display of the terminal;

FIG. 7 is a flowchart showing a procedure for editing the properties file;

FIG. 8 is a diagram showing an e-magazine screen displayed on the display of the terminal;

FIG. 9 is a diagram showing a contents screen displayed on the display of the terminal;

FIG. 10 is a diagram showing a sign-up screen displayed on the display of the terminal; and

FIG. 11 is a flowchart showing an informing procedure of the terminal.

### DETAILED DESCRIPTION OF THE PREFERRED EMBODIMENTS

This invention will be described in further detail by way of example with reference to the accompanying drawings.

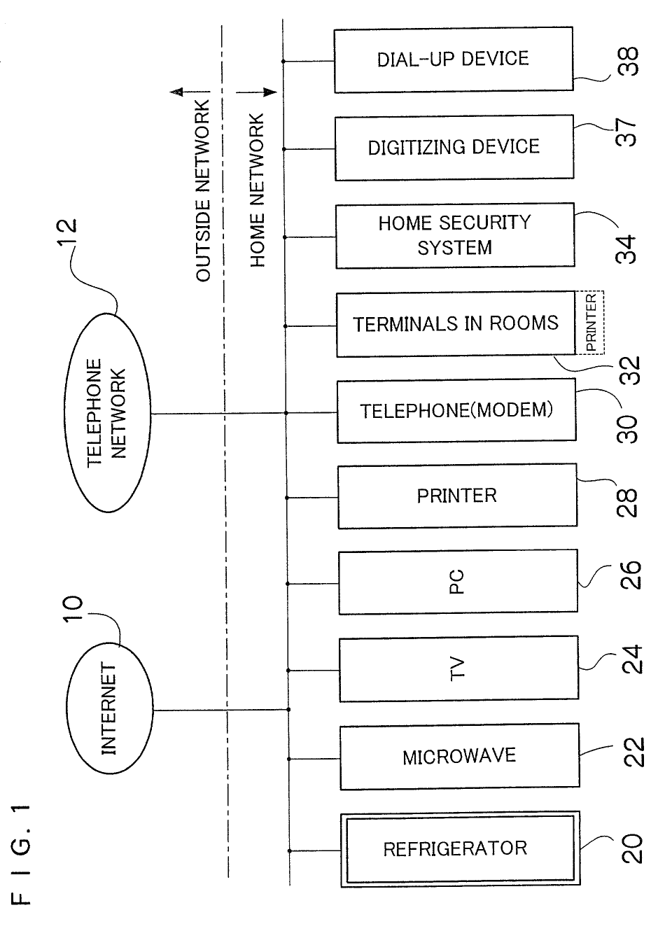

FIG. 1 is a diagram showing a structure of a home network (a local area network) connected to outside networks (wide area networks).

The outside networks are the Internet 10 and a telephone network 12 so that a telephone, a computer, etc. in the house can communicate with outside telephones, computers, etc.

The home network is composed of communication apparatuses that are a refrigerator 20, a microwave 22, a TV 24, the personal computer 26, a printer 28, the telephone 30, terminals 32 provided in all the rooms and a home security system 34.

The home network also has a digitizing device 37 that digitizes and compresses image signals obtained by the home security system 34 and image or audio signals obtained by the intercom 36, and a dial-up device 38 that dials in.

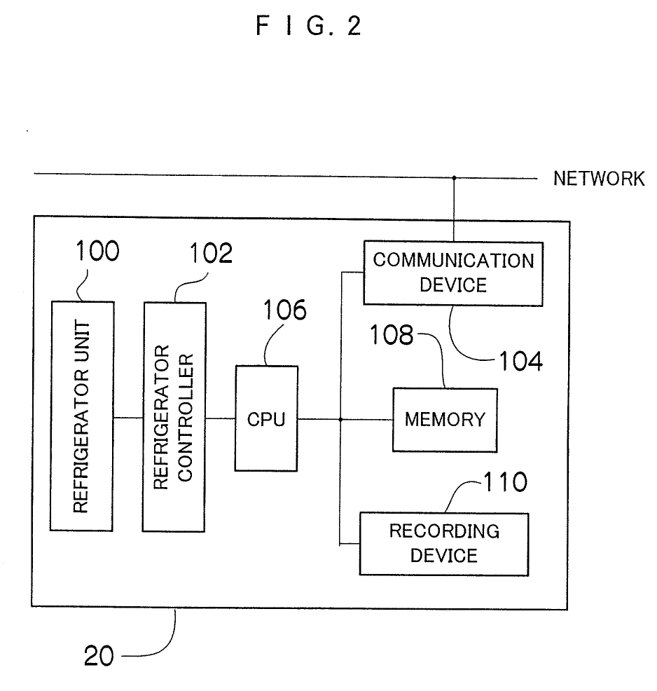

FIG. 2 is a block diagram of the refrigerator 20 if it serves as a server.

The refrigerator 20 has a refrigerator unit 100 that keeps food cold, a refrigerator controller 102 that controls the refrigerator unit 100, a communication device 104 that communicates with other communication apparatuses in the home network, and a central processing unit (CPU) 106.

The refrigerator 20 also has a memory 108 for the CPU 106, and a large-capacity recording device 110 such as a hard disc that records information on the refrigerator unit 100 and so on.

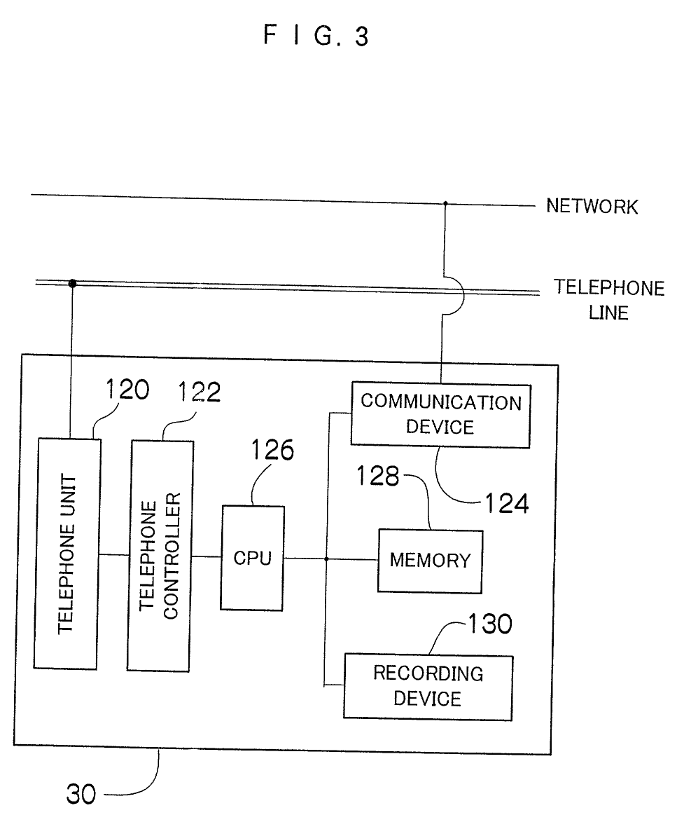

FIG. 3 is a block diagram of the telephone 30 if it serves as a server.

The telephone 30 has a telephone unit 120 that transmits and receives audio and facsimiles, a telephone controller 122 that controls the telephone unit 120, a communication device 124 that communicates with other communication apparatuses in the home network, and a central processing unit (CPU) 126.

The telephone 30 also has a memory 128 for the CPU 126, and a large-capacity recording device 130 such as a hard disc that records information on the telephone unit 120 and so on.

When one of the communication apparatuses in the home informs a user, the TV 24, the telephone 30 or one of the terminals 32 displays the information, or the printer 28 or a printer of one of the terminals 32 prints the information. Properties of the display or the printing (job) are recorded in a properties file.

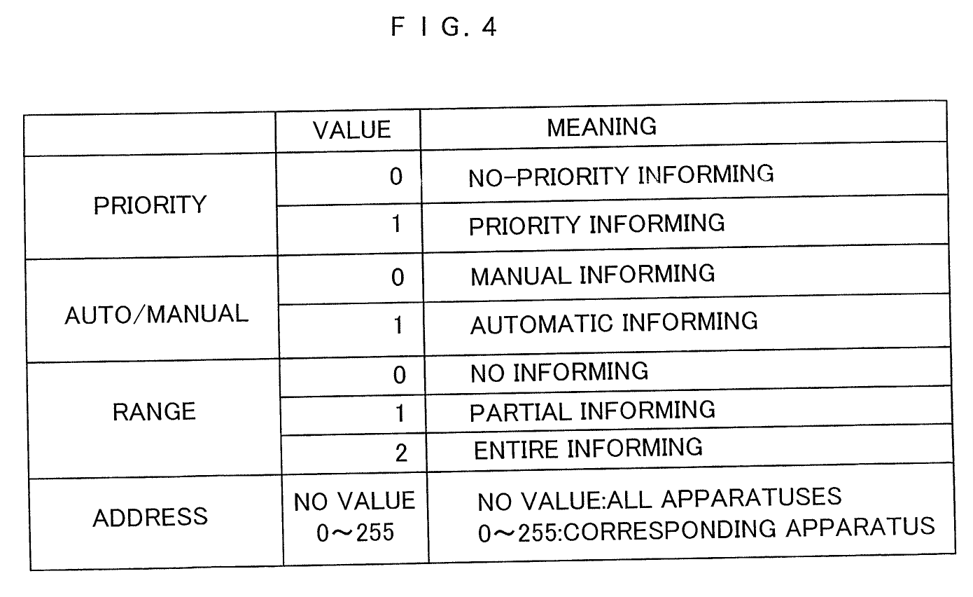

FIG. 4 shows contents of the properties file.

The properties file shows whether or not the job has priority over the other jobs, whether the job will be performed automatically or manually, a range of the job, and which communication apparatus will perform the job.

The user produces the properties file with one of the terminals 32, or the like, and one of the communication apparatuses including the server stores the properties file. When the properties file is to be used, one communication apparatus transmits the information and the properties file to another communication apparatus directly or through the server.

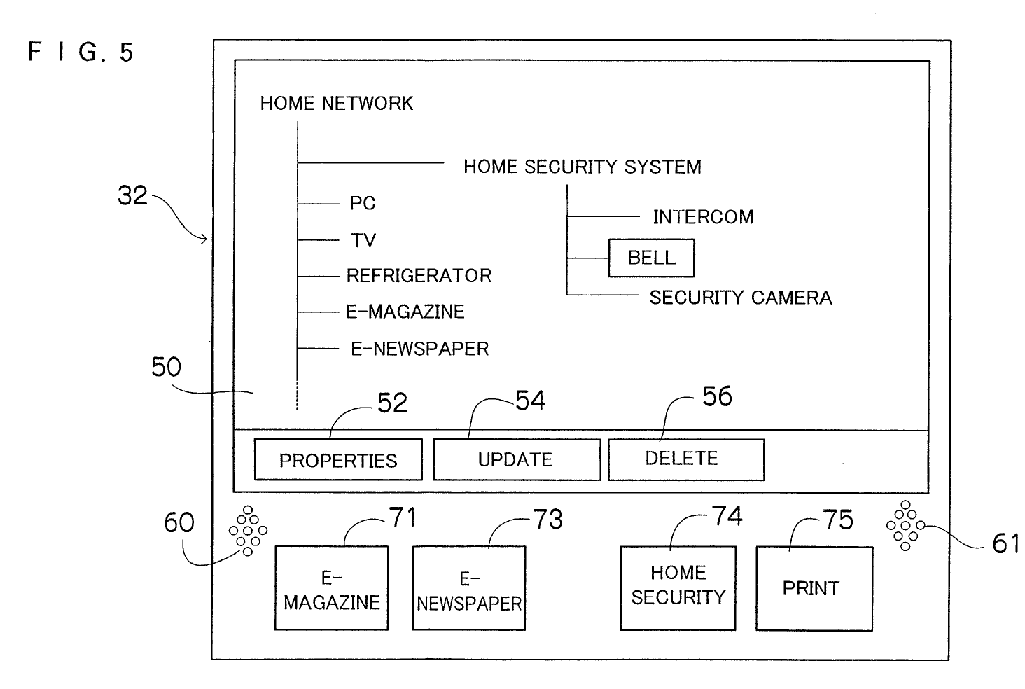

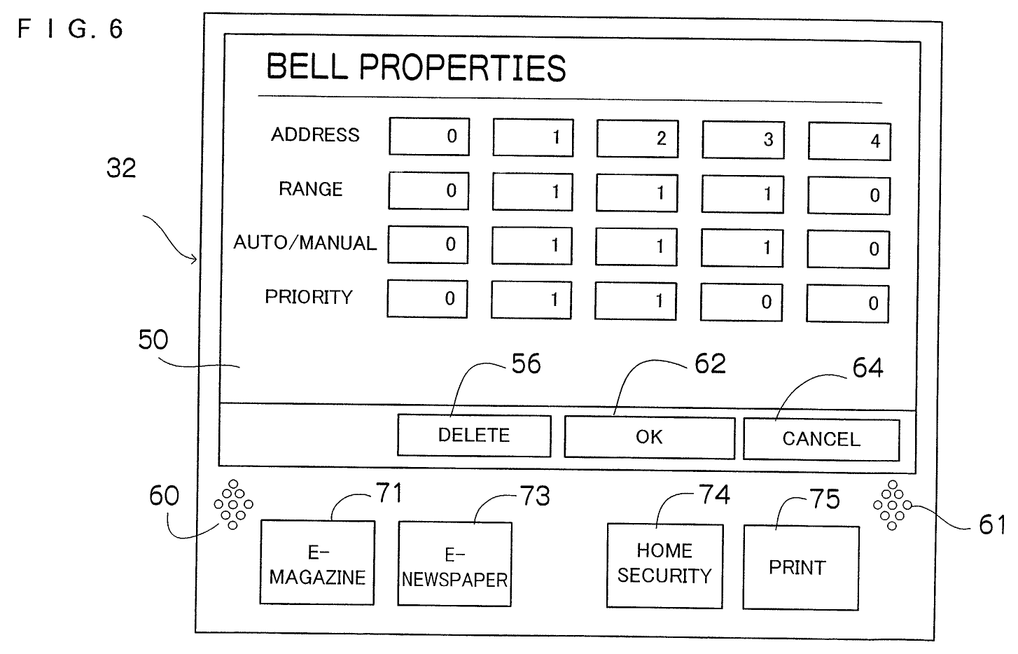

A method of producing the properties file will now be explained with reference to FIGS. 5 and 6.

FIG. 5 shows a selection screen displayed on a display 50 (a touch panel or the like) of one of the terminals 32.

The selection screen shows the communication apparatuses in the home network, and has a properties button 52 for producing the properties file, an update button 54 for updating the properties file, and a delete button 56 for deleting the properties file. In FIG. 5, a bell of the home security system 34 is selected.

The terminal 32 also has a speaker 60 that informs the user of an information reception and a malfunction and is used for the bell and an intercom of the home security system 34, and a microphone 61 used for the intercom.

If the user pushes the properties button 52, a bell properties screen shown in FIG. 6 is displayed on the display 50 of the terminal 32.

The user produces the properties file for the bell on the bell properties screen. The bell properties screen shows addresses of communication apparatuses that will perform the jobs, ranges of the jobs, whether the jobs will be performed automatically or manually, and whether or not the jobs have priority. The user can edit the properties file with the delete button 56, an OK button 62, a cancel button 64 and so on.

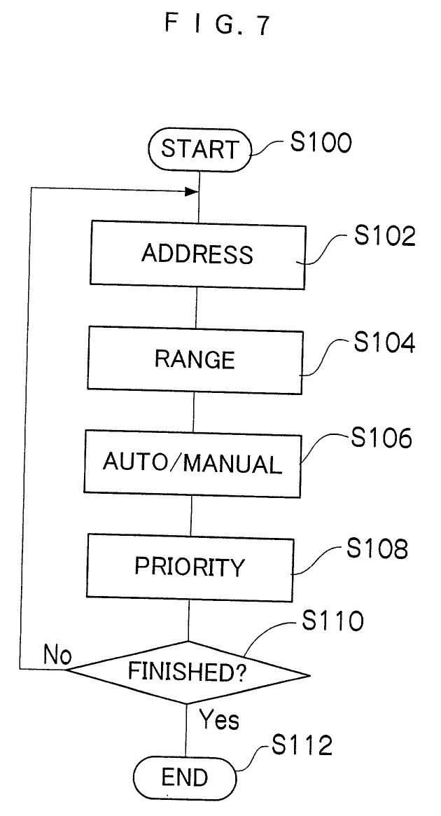

FIG. 7 is a flowchart showing a procedure for editing the properties file.

When the bell properties screen shown in FIG. 6 is displayed, a program for a central processing unit of the terminal 32 goes to S100 of “START.”

Then, the program goes to S102 of “ADDRESS,” at which the user inputs an address of one desired communication apparatus (for example, the TV). Next, the program goes to S104 of “RANGE,” at which the user inputs the range of the job. The program also goes to S106 of “AUTO/MANUAL,” at which the user determines whether the job will be performed automatically or manually. Then, the program goes to S108 of “PRIORITY,” at which the user determines whether or not the job has priority.

After that, the program goes to S110 of “FINISHED?” at which the user determines whether or not the user has selected all the desired communication apparatuses. If no, the program returns to S102 to select another desired communication apparatus. If yes, the program goes to S112 of “END” to finish editing the properties file.

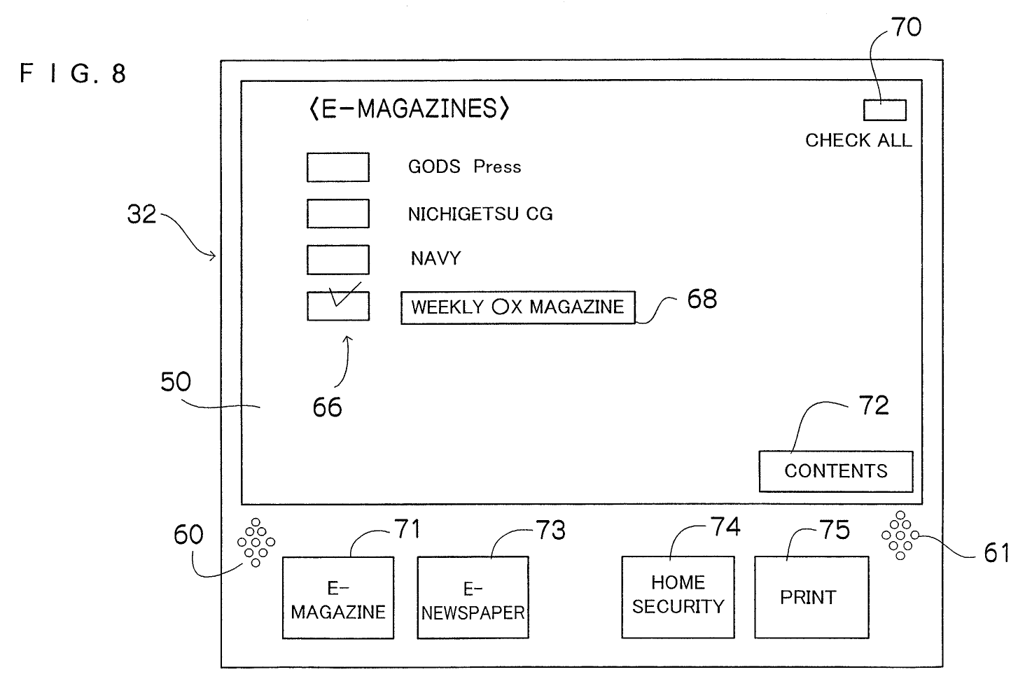

FIG. 8 shows an e-magazine screen displayed on the display 50 of the terminal 32.

The e-magazine screen is displayed if the user selects e-magazines on the selection screen shown in FIG. 5.

The e-magazine screen has checkboxes 66 for selecting e-magazines, a checkbox 70 for selecting all the e-magazines, and a contents button 72 for displaying a table of contents of the selected e-magazine. In FIG. 8, WEEKLY OX MAGAZINE is selected, and a frame 68 is displayed around the name and the name blinks when the e-magazine has been received.

The terminal 32 has indicators 71 and 73 that blink when the e-magazines and e-newspapers to which the user subscribes have been received, respectively. The terminal 32 also has a home security button 74 for displaying an image that a security camera of the home security system 34 is capturing on the display 50, and a print button 75 for printing information.

If a properties file of the security camera shows that the terminal 32 gives priority to a job from the security camera, the image that the security camera is capturing is displayed on the display 50 when the home security system 34 has detected an abnormality. If the terminal 32 is off in this case, it is turned on to perform the job.

If the properties file of the security camera shows that a mobile phone with a liquid crystal display gives priority to a job from the security camera, the user can check visitors from the outside. If a properties file of the intercom shows that the mobile phone gives priority to a job from the intercom, the user can talk to the visitors while the user is out. In this case, the digitizing device 37 in FIG. 1 digitizes and compresses the audio signals from the intercom and the image signals from the security camera, and the dial-up device 38 dials in to connect to the mobile phone.

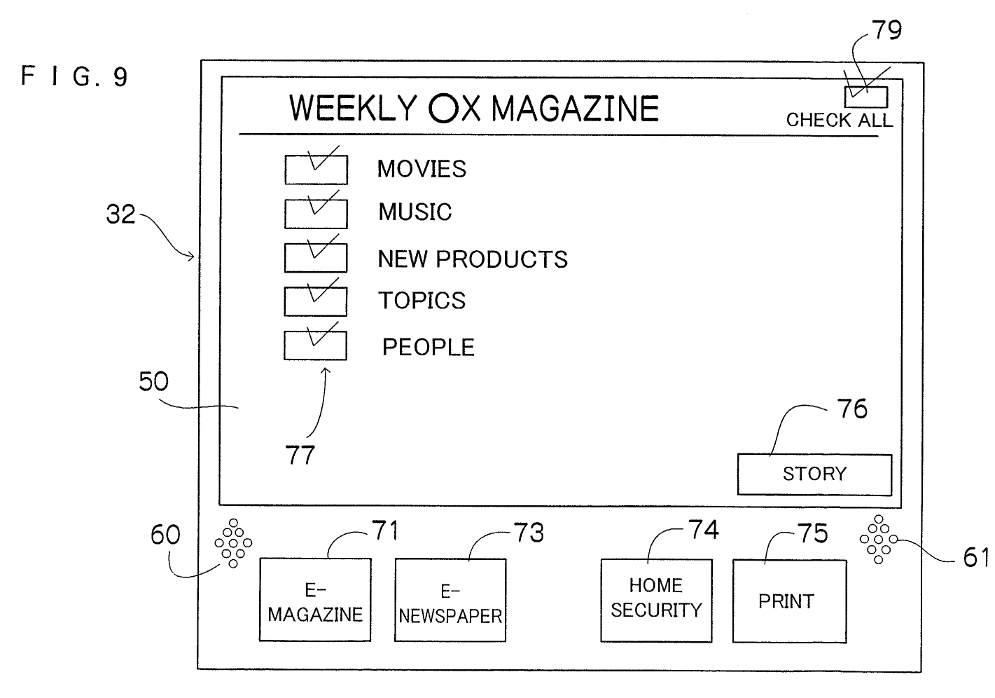

FIG. 9 shows a contents screen displayed on the display 50 of the terminal 32.

The contents screen is displayed when the user presses the contents button 72 on the e-magazine screen shown in FIG. 8.

The contents screen has checkboxes 77 for selecting items (movies, music, new products, topics and people), a checkbox 79 for selecting all the items, and a story button 76 for displaying stories of the selected items.

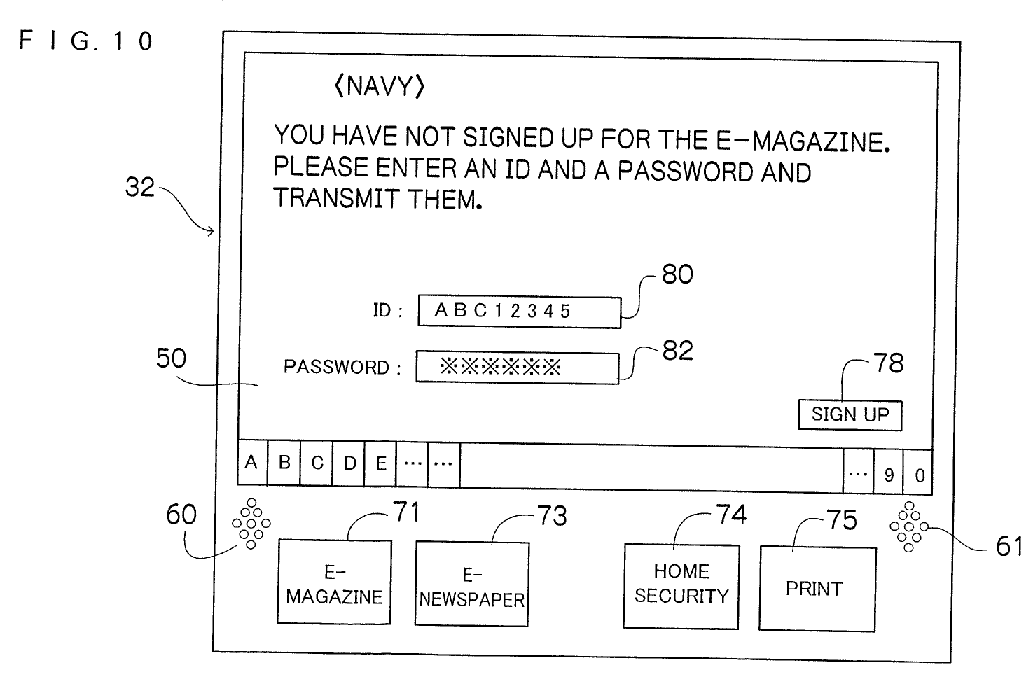

FIG. 10 shows a sign-up screen displayed on the display 50 of the terminal 32.

The sign-up screen is displayed when the user selects NAVY on the e-magazine screen shown in FIG. 8.

The sign-up screen displays a message saying that the user has not signed up for the e-magazine and telling the user to enter an ID and a password and transmit them. The sign-up screen has an ID box 80 for the ID of the user, a password box 82 for the password, and a sign-up button 78 for transmitting the ID and the password.

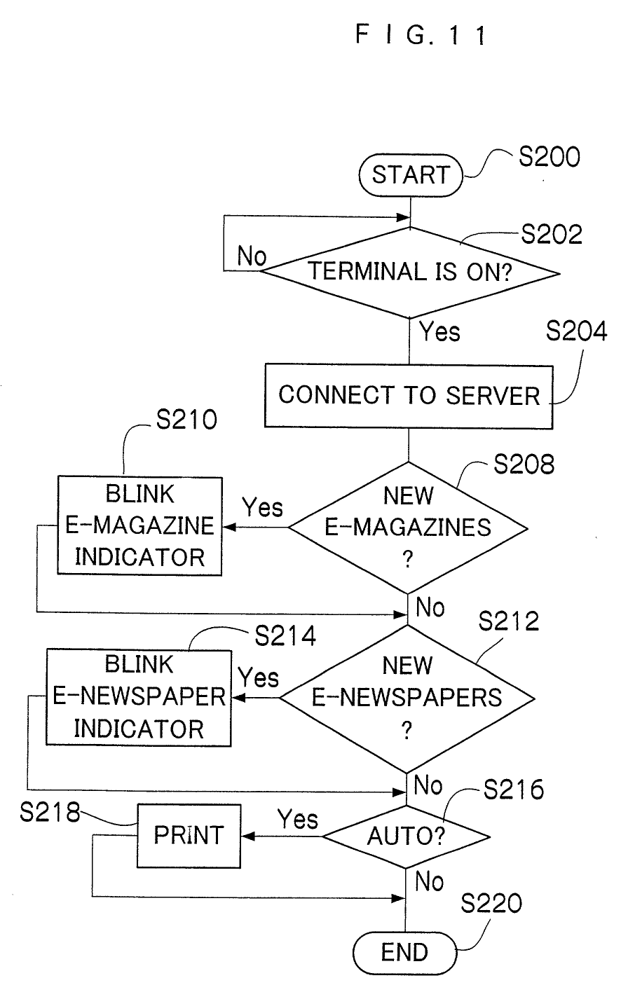

FIG. 11 is a flowchart showing an informing procedure of the terminal 32.

When the terminal 32 is off, the program goes to S200 of “START” and S202 of “TERMINAL IS ON?” to wait until the terminal 32 is turned on. When the terminal 32 has been turned on at S202, the program goes to S204 of “CONNECT TO SERVER” to connect to the server (the refrigerator).

Then, the program goes to S208 of “NEW E-MAGAZINES?” to determine whether or not new e-magazines have been received. If yes, the program goes to S210 of “BLINK E-MAGAZINE INDICATOR” to blink the indicator 71. The speaker 60 may be used at this time.

Next, the program goes to S212 of “NEW E-NEWSPAPERS?” to determine whether or not new e-newspapers have been received. If yes, the program goes to S214 of “BLINK E-NEWSPAPER INDICATOR” to blink the indicator 73.

After that, the program goes to S216 of “AUTO?” to determine whether or not the printing will be performed automatically. If yes, the program goes to S218 of “PRINT” for the printing. The printer of the terminal 32 may perform the printing, and the printer 28 in the home network may perform the printing. The information may be displayed on the display 50 of the terminal 32. If the printer 28 does not have enough paper, the display 50 may display a message indicating that.

If no at S216 or after the printing at S218, the program goes to S220 of “END” to end the informing.

The home network is explained in the embodiment, but the present invention may be applied to any local area network.

As set forth hereinabove, according to the present invention, the informing system for informing the user through the local area network comprises the properties file producing device that produces the properties file showing the following; whether or not the informing job has the priority over the other informing jobs, whether the informing job will be performed automatically or manually, the range of the informing job, and which communication apparatus will perform the informing job; and the informing device that informs the user according to the properties file produced by the properties file producing device. Therefore, the informing job can be appropriately performed according to the priority and so on of the informing job.

Since the properties file shows the range of the informing job, one of the communication apparatuses (such as the TV) can display the information so that the information is not an obstruction when the user is using the communication apparatus (watching TV).

In addition, since the home network is connected to the outside networks, terminals such as the mobile phone can communicate with the communication apparatuses from the outside.

Moreover, since the server is the refrigerator or the telephone that is never turned off, the informing system is reliable.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An informing system for informing a user through a local area network, the informing system comprising:
a properties file producing device that produces a properties file showing at least one of the following; whether or not an informing job has priority over other informing jobs, whether the informing job will be performed automatically or manually, a range of the informing job, and which communication apparatus will perform the informing job; and
an informing device that informs the user according to the properties file produced by the properties file producing device.

2. The informing system as defined in claim 1, wherein the informing device turns on the communication apparatus if the properties file shows that the informing job has the priority over the other informing jobs.

3. The informing system as defined in claim 1, wherein the local area network is a home network in a home.

4. The informing system as defined in claim 3, wherein the informing device turns on the communication apparatus if the properties file shows that the informing job has the priority over the other informing jobs.

5. An informing system for informing a user through a local area network, the informing system comprising:
a properties file producing device that produces a properties file showing at least one of the following; whether or not an informing job has priority over other informing jobs, whether the informing job will be performed automatically or manually, a range of the informing job, and which communication apparatus will perform the informing job;
a server that stores the properties file produced by the properties file producing device; and
an informing device that informs the user according to the properties file stored in the server.

6. The informing system as defined in claim 5, wherein the informing device turns on the communication apparatus if the properties file shows that the informing job has the priority over the other informing jobs.

7. The informing system as defined in claim 5, wherein the local area network is a home network in a home.

8. The informing system as defined in claim 7, wherein the informing device turns on the communication apparatus if the properties file shows that the informing job has the priority over the other informing jobs.

9. The informing system as defined in claim 5, wherein the server is one of a refrigerator and a telephone that can transmit and receive information through the local area network.

10. The informing system as defined in claim 9, wherein the informing device turns on the communication apparatus if the properties file shows that the informing job has the priority over the other informing jobs.

11. The informing system as defined in claim 9, wherein the local area network is a home network in a home.

12. The informing system as defined in claim 11, wherein the informing device turns on the communication apparatus if the properties file shows that the informing job has the priority over the other informing jobs.

13. An informing method for informing a user through a local area network, the informing method comprising the steps of:
producing a properties file showing at least one of the following; whether or not an informing job has priority over other informing jobs, whether the informing job will be performed automatically or manually, a range of the informing job, and which communication apparatus will perform the informing job; and
informing the user according to the properties file.
